(19) United States
(12) Patent Application Publication
(10) Pub. No.: US 2013/0110943 A1
(43) Pub. Date: May 2, 2013

(54) NOTIFICATION AND REMINDER GENERATION, DISTRIBUTION, AND STORAGE SYSTEM

(71) Applicants: Sanjay Menon, Sunnyvale, CA (US); Krishnendu Chakraborty, Fremont, CA (US); Tanmoy Bhattacharya, Mangalore (IN)

(72) Inventors: Sanjay Menon, Sunnyvale, CA (US); Krishnendu Chakraborty, Fremont, CA (US); Tanmoy Bhattacharya, Mangalore (IN)

(73) Assignee: APPLE INC., Cupertino, CA (US)

(21) Appl. No.: 13/287,973

(22) Filed: Nov. 2, 2011

(51) Int. Cl. G06F 15/16

(52) U.S. Cl. 709/206

(57) ABSTRACT

A centralized notification engine, which serves notifications from multiple applications, receives a request to register a notification from a particular application. Responsive to the request, the notification engine stores information that indicates a context of the notification. The notification engine determines whether the notification satisfies metadata-specified constraints. Responsive to determining that the notification satisfies the constraints, the notification engine selects, from a set of templates, a template that is associated with the notification's context. The notification engine applies the template to information specified by the notification. As a result, a populated template is produced.

### FIELD OF THE INVENTION

The present invention relates to a computerized system for generating, distributing, and storing notifications.

### BACKGROUND

Many organizations try to build custom mechanisms to send notifications to internal and external customers. Such notifications may be sent via e-mail, for example. Typically, notifications sent to internal and external recipients vary vastly from one another since the content and format of these notifications differ on specific rules that dictate the user interaction with the system or application. On a typical day in any big organization in which large numbers of notifications are being sent to employees, retail stores, and customers, employees get e-mails related to the accounts they are trying to create or privileges they are trying to obtain for specific application or resources. Within large organizations, each application maintains its own mechanism to notify the customer on the status of the customer's request. In the consumer business, there is greater need to consolidate internal, retail, and external e-mails to create a unified look and feel for all emails sent internally and externally.

In a decentralized notification system, every application maintains its own custom mechanisms and rules to generate, store, and send notifications. There are some drawbacks that attend the use of a decentralized system, though. In a decentralized system, the formats of notification e-mails are not standardized between applications, and are usually manually generated. In a decentralized system, there is no central repository in which notification rules can be registered. In a decentralized system, there is no central repository in which to retain either the finalized content of notifications that are sent or the input that was used to determine that content. In a decentralized system, as business requirements change, additional time and effort is required to generate new notifications manually. In a decentralized system, there is no data model that encompasses all types of notifications regardless of whether those notifications are internal or customer-focused.

A business organization's provisioning system may interact with numerous internal and external components in order to send notifications to employees, customers, and system administrators. The total number of such notifications may lie in the range of several thousand notification e-mails per day. Most of these e-mails may be critical for business. These notifications may be generated for various use cases that include multifarious business requirements, such as provisioning new employees on company accounts, creating new accounts for retail and store employees, providing reports and alarms to system administrators and users, etc. There is little commonality among these applications. The notifications that are sent by these applications differ from each other with regard to content and context depending business rules. This difference in notifications between applications makes the maintenance and updating of notifications over time a tremendous challenge.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

In the drawings:

FIG. 1 is a block diagram that illustrates a data model for a notification engine, according to an embodiment of the invention.

FIG. 2 is a block diagram that illustrates example names and purposes of various columns in the notification header table and the notification metadata table, according to an embodiment of the invention.

FIG. 3 is a block diagram illustrating an example of a client's interaction with the notification engine, according to an embodiment of the invention.

FIG. 4 is a flow diagram illustrating an example of an overview of a technique for processing client notification requests at a notification engine, generating notifications, and sending those notifications to recipients, according to an embodiment of the invention.

FIG. 5 is a flow diagram that illustrates a more detailed example of a technique that the notification engine can use to generate a notification envelope, according to an embodiment of the invention.

FIG. 6 is a flow diagram that illustrates a more detailed example of a technique that the notification engine can use to dispatch a notification to a recipient, according to an embodiment of the invention.

FIG. 7 is a block diagram that illustrates a computer system upon which an embodiment of the invention may be implemented.

FIG. 8 is a diagram that illustrates a screenshot of a collated message of the kind that is produced by one embodiment of the invention.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### Notification Engine Overview

A consolidated notification system is described herein. The consolidated notification system includes a central notification engine that can register, send, and store notifications generated by a multitude of diverse applications. The notification engine is able to decipher every application request and associate, with each such request, request-related business rules that determine when a notification will be generated and what the content of the notification will be.

In one aspect, the notification engine provides centralized notification generation and distribution. The notification engine is a single service in which each application registers all of its prospective notifications. The notification engine is also a single service through which each application sends its notifications. The notification engine supports various notification formats. The notification engine interacts with each application to deliver that application's custom content in a format that the application itself can determine.

In one aspect, the notification engine provides interfaces that allow applications to configure the formats of their notification dynamically. Each application can specify application-customized notification headers, footers, bodies, or any other notification message parts via rules that are registered, with the notification engine, for the application. The notification engine includes a transformation mechanism that sends the final content of each notification to its recipient. This transformation mechanism may be independent of the specified input and output formats of the notification.

In one aspect, the notification engine is agnostic to the underlying mechanism that actually sends a notification to its recipient. The notification delivery mechanism can be modified or substituted entirely with another notification delivery mechanism without the knowledge of any end user.

In one aspect, the notification engine hosts all generated notifications even after their delivery so that those notifications can be regenerated at any time in the future for compliance, report generation, or legal purposes.

In one aspect, the notification engine translates all notification requests to conform to a predefined set of templates that can be extended over time.

In one aspect, the notification engine consolidates multiple separate e-mail notifications based on various constraints like elapsed time and quantity of accounts generated. The notification engine may then send a single collated e-mail notification instead of sending multiple email notifications to the recipient.

In one aspect, all rules and constraints for applications interacting with the notification engine are centralized within the engine itself, making these rules and constraints easily accessible. The notification rule engine is sufficiently generic to store any kind of rules that are specific to sending notifications.

In one aspect, notifications are delivered asynchronously. Hence, callers of the notification engine can register and configure callback Uniform Resource Locators (URLs) which the notification engine may call in response to either the successful sending of a notification or the abandonment of attempts to send a notification. The callback URLs may be associated with different statuses, such as transmission success or transmission failure, so that the notification engine calls the appropriate callback URL depending on the outcome of the attempt to send a notification.

In one aspect, the notification engine hosts notification content in the form of Extensible Markup Language (XML) and Extensible Stylesheet Language (XSL). The content hosted in this form may include variables that are derivable by the notification engine. Callers of the notification engine can also supply notification content in the form of key value pairs if those callers do not want the notification engine to derive that content. The transformation mechanism may translate notification content from XML to Hypertext Markup Language (HTML), but the transformation mechanism also may be configured to translate notification content from any other specified input format to any other specified output format.

In one aspect, the notification engine provides a public service URL that any user internal or external to the business organization operating the notification engine can use to send reminders of notifications. The notification engine's interface allows users to register system-specific metadata and rules without requiring those users to upload those metadata or rules to the engine manually. The notification engine supports various protocols for this interface, including Hypertext Transfer Protocol (HTTP), JAVA Remote Method Invocation (RMI), JAVA Architecture for XML Binding (JAXB), etc. The diversity of protocols supported by the notification engine makes it easy for users to interact with the notification engine.

In one aspect, the notification engine has the ability to localize (i.e., customize based on location) notification content based on the locale that is specified for the notification's recipient.

In one aspect, the application programming interfaces (APIs) of the notification engine are transparent. The notification exposes a single API. The notification engine itself determines, based on the user action indicated in the invocation of the API, whether the notification engine needs to register or cancel a notification. In one aspect, the caller invokes a “notify” method for state changes to all objects which can trigger notifications. The notification engine responsively sends, cancels, or ignores notifications.

In one aspect, using the notification data, the notification engine generates reports on activities at scheduled intervals (e.g., daily reports for various systems). In the notification system, the completion of each significant activity triggers a notification. The notification engine may report on such activities by reporting on the notifications generated for those activities.

In one aspect, each notification also has a “reminders” property. This “reminders” property enables the notification engine to generate and send reminders based on configurations per action or based on a value overridden by a caller at the time of submitting a notification. After submitting such a notification, the caller does not need to bother with the reminders; the notification engine takes care of sending out the reminders at the appropriate time.

In one aspect, the notification engine detects errors and informs about those errors. For example, the notification engine may trigger an alarm in response to detecting a sudden surge in notifications beyond the average number. For another example, one instance of the notification engine may detect that the quantity of queued-up notifications exceeds a specified threshold, and, in response, silently suspend all notifications and trigger an alarm, thereby allowing that instance of the notification engine to shift at least some portion of the notification load to other instances of the notification engine.

In one aspect, the notification engine can be configured to release certain notifications, such as blocked or error-producing notifications, only in response to manual intervention. In one aspect, the notification engine can be configured to suspend certain notifications in response to manual intervention.

In one aspect, the notification engine waits to send notifications (e.g., notifications regarding the creation of user accounts) destined for a particular recipient until the notification engine receives assurance that the particular recipient's e-mail account has been established and is available. This feature is especially useful when the notification recipient is a new hire to the business organization operating the notification engine, because sometimes a new hire's other accounts may be created before that new hire's e-mail account is created.

In one aspect, the notification engine generates alarm reports which notify users about notifications that have failed or that have been suspended for a period of time that exceeds a specified threshold.

In one aspect, the notification engine is fault-tolerant. Each instance of the notification engine automatically distributes its load to other instances when that instance is under stress or is starting to behave erratically. All notification data is finally persisted in a database. The notification system remains live even if an individual data center completely goes down.

### Data Model for Notification Engine

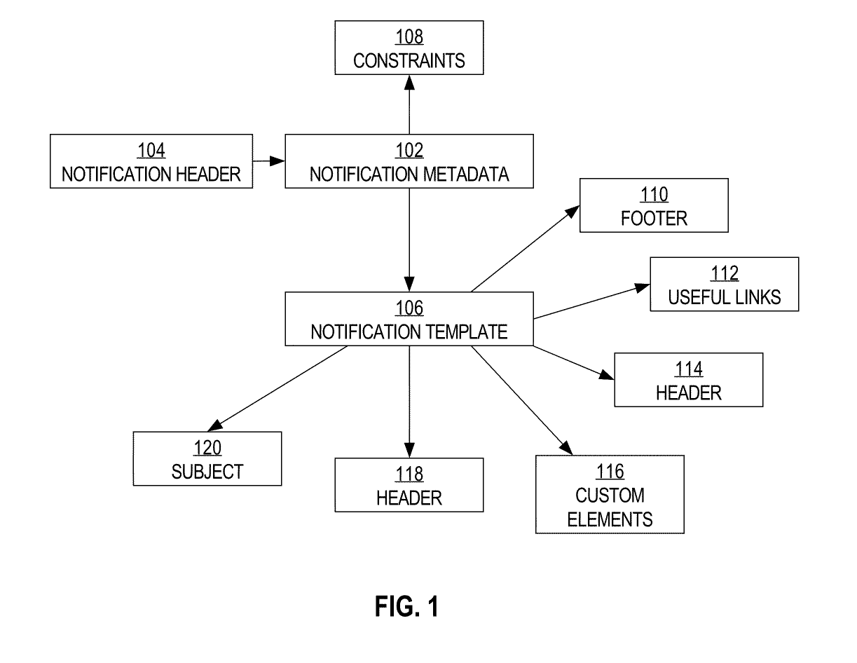

According to one embodiment of the invention, the notification engine data model is sufficiently generic to capture all notifications for any specific domain. The model can support notifications from any part of an organization and can be extended to store additional notification data or metadata. FIG. 1 is a block diagram that illustrates a data model for a notification engine, according to an embodiment of the invention. According to one embodiment of the invention, each component shown in FIG. 1 corresponds to a separate relational table within a database. FIG. 1 illustrates how these relational tables relate to each other.

Notification header table 104 stores all the actual data related to each specific notification, including final notifications that are generated by the notification system. Notification header table essentially stores data that indicates the user-informative content of the notification message; the expression of this content to the user is the notification's core purpose. Example contents of notification header table 104 are presented in a separate section further below.

Notification metadata table 102 stores all metadata related to each notification. The rows of notification metadata table 102 have a one-to-many relationship with constraints in constraint table 108; each metadata item may be related to many different constraints. Constraints are rules associated with a notification. These rules indicate how a notification will be sent. The rows of notification metadata table 102 contain references to corresponding rows in notification template table 106. The rows of notification metadata table 102 also may refer to message context, reminder data, user action, locale (language), subject, etc.

Notification template table 106 refers to all templates in the notification engine. Each such template specifies a format for a notification. The rows of notification template table 106 refer to all of the different parts of a notification message. The parts include subject, header, footer, etc. As shown in FIG. 1, each row of notification template table 106 refers to corresponding rows in footer table 110, useful links table 112, header table 114, custom elements table 116, body table 118, and subject table 120. A user or customer has the ability to inject text specific to that user's application in any of the fragments (stored in tables 110-120) and customize that text. The notification engine then gathers all the notification message components from these tables and creates the combined template for all of the specific notifications.

Although FIG. 1 illustrates an embodiment of the invention that includes tables 102-120, in alternative embodiments of the invention, the data model includes fewer tables than those shown. For example, in one alternative embodiment of the invention, the data model includes only tables 102 and 104. In such an alternative embodiment, notification metadata table 102 may include all of the information shown in FIG. 1 to be contained within tables 106-120.

The segregation of the notification data, metadata, and template in this data model provides significant strength to the notification engine's ability to customize a notification as dictated by a user. This segregation also helps the notification engine to configure the rules related to a specific application.

### Notification Templates

Each notification is associated with an unique context or key. According to one embodiment of the invention, each notification has four notification elements that collectively determine the context of that notification. These notification elements are: (1) recipient, (2) recipient type, (3) action, and (4) Context (for example Approver). Based on this known combination of elements of a notification, the notification engine selects, from the set of different templates stored in notification template table 106, a particular template that corresponds to that combination of elements. In one embodiment of the invention, notification template table 106 initially stores a set of highly generic pre-defined templates. Notification designers can add, to notification template table 106, their own customized templates, some of which may be application-specific. By maintaining a store of standardized templates in notification template table 106, the look and feel of notifications within a business organization can be made consistent between applications and contexts. For example, any time that an account is created for any application in the system, the notification engine can use an account creation template that is stored in notification template table 106. A notification designer can choose an existing template from notification template table 106 or generate a new, more specific template by changing parts of such an existing template like the header, footer, etc.

Listed below are some example standard templates that the notification engine hosts, in one embodiment of the invention. In the list, words enclosed within < and > indicate variables whose values may be supplied to a template and used to fill in designated parts of the template in order to compose the actual notification that will be sent. In the list, the term resources mentioned may be any resources that may be provisioned to a user, potentially in response to the user's request, such as a virtual machine, or an SSL certificate, for example.

“Notification: ‘<System>’—New Account Information” is a standard template that indicates a format for a notification that informs a user about information pertaining to a new account that has been established for a user in a specified system.

“Notification: ‘<System>’—Account Updated” is a standard template that indicates a format for a notification that informs a user about information pertaining to updates that have been made to an existing account of the user in a specified system.

“Notification: ‘<System>’—Account Deleted” is a standard template that indicates a format for a notification that informs a user about information pertaining to the deletion of a previously existing account of the user in a specified system.

“Notification: ‘<System>’—Account Reactivated” is a standard template that indicates a format for a notification that informs a user about information pertaining to the re-activation of a previously suspended or expired account of the user in the specified system.

“Notification: ‘<System>’—Account Renewed” is a standard template that indicates a format for a notification that informs a user about information pertaining to the renewal of an existing account of the user in the specified system.

“Notification: ‘<System>’—Approval Required” is a standard template that indicates a format for a notification that informs a user that approval is required before a requested resource in the specified system can be provisioned to the user.

“Notification: ‘<System>’—More Information Required” is a standard template that indicates a format for a notification that informs a user which additional information is required from the user before a requested resource in the specified system can be provisioned to the user.

“Notification: ‘<System>’—Request Denied” is a standard template that indicates a format for a notification that informs a user that the user's request to have a resource in the specified system provisioned to the user has been denied.

“Notification: ‘<System>’—Request Canceled” is a standard template that indicates a format for a notification that informs a user that the user's request to have a resource in the specified system provisioned to the user has been canceled (potentially due to the user's own cancellation of that request).

“Notification: ‘<System>’—Request Confirmation” is a standard template that indicates a format for a notification that informs a user that the user's request to have a resource in the specified system provisioned to the user has been received by the provisioning system.

“Notification: ‘<System>’—Renewal Request” is a standard template that indicates a format for a notification that informs a user about information pertaining to a renewal request in the specified system.

“Notification: ‘<System>’—Approval Reminder” is a standard template that indicates a format for a notification that reminds the user that his approval of another user's request for a resource in the specified system is needed.

“Notification: ‘<System>’—Privilege Expiration” is a standard template that indicates a format for a notification that informs a user that a privilege that the user previously had in the specified system has expired.

“Notification: ‘<System>’—Account Expiration” is a standard template that indicates a format for a notification that informs a user that an existing account of the user in the specified system has expired or will expire.

“Notification: Account Suspended—<FN> <LN> (<DSID>)” is a standard template that indicates a format for a notification that informs a user that an existing account of the user in the specified system has been suspended. Variable <FN> is populated with a specified first name of the user. Variable <LN> is populated with a specified last name of the user. Variable <DSID> is populated with a specified unique directory services identifier of the user.

“Notification: Account Reactivated—<FN> <LN> (<DSID>)” is a standard template that indicates a format for a notification that informs a user that a previously suspended or expired account of the user in the specified system has been re-activated. Variable <FN> is populated with a specified first name of the user. Variable <LN> is populated with a specified last name of the user. Variable <DSID> is populated with a specified unique directory services identifier of the user.

“Notification: Immediate Account Termination—<FN> <LN> (<DSID>)” is a standard template that indicates a format for a notification that informs a user that an existing account of the user in the specified system has been terminated immediately (potentially due to termination of the user's employment). Variable <FN> is populated with a specified first name of the user. Variable <LN> is populated with a specified last name of the user. Variable <DSID> is populated with a specified unique directory services identifier of the user.

“Notification: Business Account Termination—<FN> <LN> (<DSID>)” is a standard template that indicates a format for a notification that informs a user that an existing business account of the user in the specified system has been terminated. Variable <FN> is populated with a specified first name of the user. Variable <LN> is populated with a specified last name of the user. Variable <DSID> is populated with a specified unique directory services identifier of the user.

“Notification: ‘<Resource Name>’—New <Resource Type> Information” is a standard template that indicates a format for a notification that informs a user about information pertaining to the existence of a new resource having a specified name and type. The type might be, for example, a virtual machine type, and the name might be the name of an instance of a virtual machine of that type.

“Notification: ‘<Resource Name>’—<Resource Type> <Completed Action>” is a standard template that indicates a format for a notification that informs a user about information pertaining to the completion of a specified action relative to a resource having a specified name and type. For example, if the resource is of a virtual machine type, then the action might indicate the virtual machine has started or stopped.

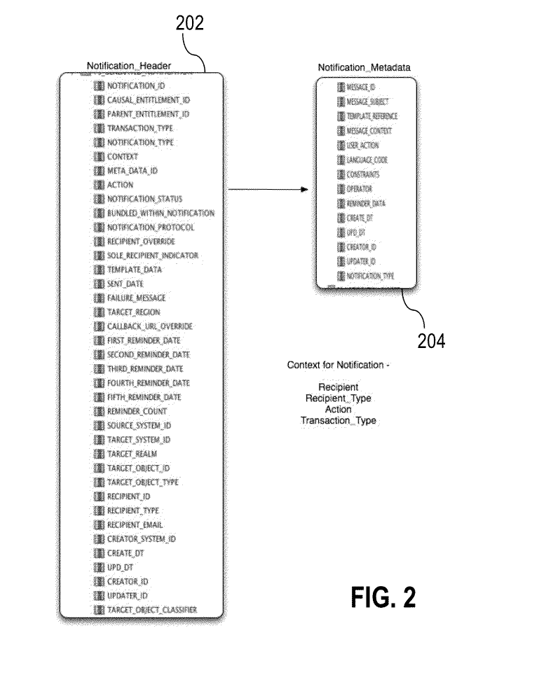

FIG. 2 is a block diagram that illustrates example names and purposes of various columns in the notification header table and the notification metadata table, according to an embodiment of the invention. Notification header table 202 (corresponding to notification header table 104 of FIG. 1) contains columns storing a notification ID (which uniquely identifies the notification), a causal entitlement ID (aka causal request id), a parent entitlement ID (aka causal entitlement id), a transaction type, a notification type, a context, a metadata ID (which may be populated with a reference to a row in notification metadata table 102 of FIG. 1), an action (e.g., account creation, deletion, etc.), a notification status, a bundled written notification, a notification protocol, a recipient override, a sole recipient indicator, template data, a sent date, a failure message, a target region, a callback URL override, first through fifth reminder dates, a reminder count, a source system ID, a target system ID, a target realm, a target object ID, a target object type (e.g., a type of an object to which the notification pertains, such as “virtual machine”), a recipient ID, a recipient type, a recipient e-mail address, a creator system ID, a create date, an update date, a creator ID, an updater ID, and a target object classifier. Of these, a combination of the values of recipient ID, recipient type, action, and transaction type columns may be matched to a combination of values of similar columns in notification template table 106 of FIG. 1 in order to select a template for the notification from notification template table 106. Notification header table 202 contains the notification data itself.

Notification metadata table 204 (corresponding to notification metadata table 102 of FIG. 1) contains columns storing a message ID, a message subject, a template reference (which may be populated with a reference to a row in notification template table 106 of FIG. 1), a message content, a user action, a language code, constraints (which may be populated with references to rows in constraints table 108 of FIG. 1), an operator, reminder data, a create date, an update date, a creator ID, an updater ID, and a notification type. Notification metadata table 204 contains metadata pertaining to the behavior of a notification. Behavior in this context includes the format of the notification, the entities to which the notification is to be sent, and the times at which the notification is to be sent. The notification metadata essentially indicates how a notification looks (template) and how the notification acts (constraints).

The schemas for the tables described above are merely one example of a multitude of different schemas to which such tables could conform in alternative embodiments of the invention.

Since the final generated notification is kept in notification header table 202, users and applications can query the generated notification any time. In this way, users and applications can retrieve data for previously sent notifications if they need to do so for compliance purposes. User and applications can also retrieve data related to the generation of such previously sent notifications. In one embodiment of the invention, the notification engine is associated with an administrator user interface through which an administrator can enter such queries. Alternatively, an administrator could issue Structured Query Language (SQL) queries directly to the database in order to retrieve previously sent notification information.

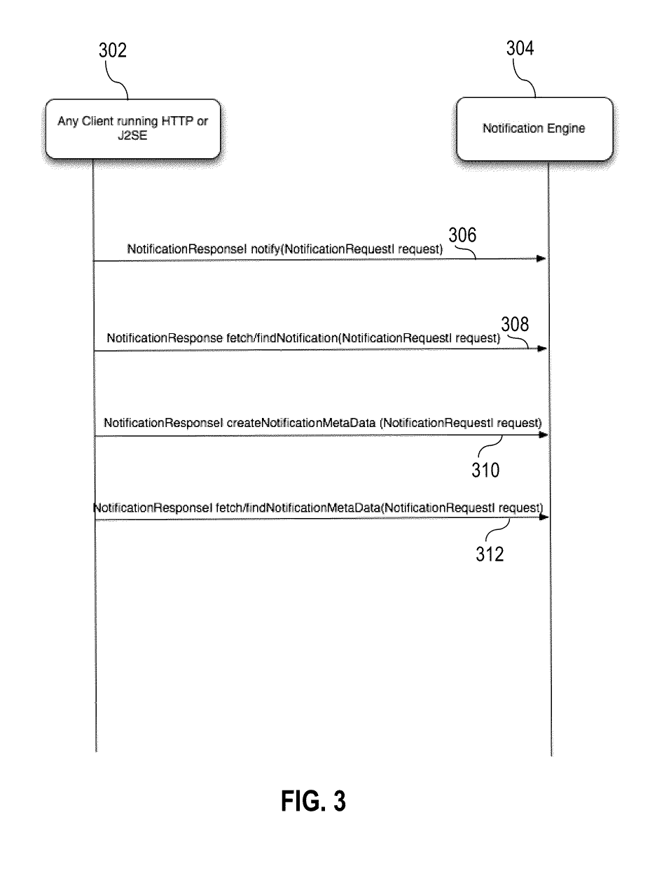

FIG. 3 is a block diagram illustrating an example of a client's interaction with the notification engine, according to an embodiment of the invention. A client 302 (which may be any one of multiple separate clients that concurrently interact with the notification engine) can communicate with notification engine 304 by calling (306) a “notify(NotificationRequest request)” method of an API of notification engine 304. This API allows client 302 to talk with notification engine 304 and send all the data related to the specific notification instance. Client 302 uses call 306 to (among other possible operations) register a new notification with notification engine 304. According to one embodiment of the invention, every call to notification engine 304 specifies a NotificationResponse object. Client 302 can call notification engine 304 through any transport protocol like HTTP, sockets, JAXB, Web Services, etc. The interface is generic and can be supported through any transport mechanism.

Client 302 may use JAVA 2 Platform Standard Edition (J2SE), for example. Client 302 may be any one of the many applications in a business organization that seeks to send notifications to people in that organization. Notification engine 304 may be implemented as a computer process or as a thread of a multi-threaded process, for example. Notification engine 304 consolidates and routes, to recipients, all of the notifications from all of the applications in the business organization.

Client 302 may call (308) a “fetchNotification(NotificationRequest request)” method and/or a “findNotification(NotificationRequest request)” method of the API in order to find and fetch notifications that already have been sent. In one embodiment of the invention, one method permits client 302 to query for a single specific notification (e.g., by notification ID or other field), while another method permits client 302 to query for all notifications that match a specified pattern, such as a string pattern.

Client 302 may call (310) a “createNotificationMetadata(NotificationRequest request)” method of the API in order to create the metadata for the specified request object. This call is not mandatory if the metadata is already created, but is used to create the metadata if the metadata does not exist. This call also provides client 302 the ability to change any metadata pertaining to a notification. For example, using call 310, client 302 may modify constraints or rules attached to a specified notification or system or recipient. For another example, using call 310, client 302 may modify the context of the notification, reminders, template, etc.

Client 302 may call (312) a “fetchNotificationMetadata(NotificationRequest request)” method and/or a “findNotificationMetadata(NotificationRequest request)” method of the API in order to find and fetch metadata for notifications that already have been sent. In one embodiment of the invention, one method permits client 302 to query for metadata of a single specific notification (e.g., by notification ID or other field), while another method permits client 302 to query for metadata of all notifications that match a specified pattern, such as a string pattern.

In one embodiment of the invention, there is a many-to-one relationship between notifications and notification metadata, such that after a particular set of metadata is registered with notification engine 304, that metadata is applicable to multiple different notifications that are registered with notification engine 304. However, in an alternative embodiment of the invention, there is a one-to-one relationship between a notification and metadata for that notification, such that each notification has its own metadata that is applicable to that notification only.

In one embodiment of the invention, notification engine 304 includes the following APIs: (1) NotificationServiceI, which is a service API for the notification engine; (2) NotificationRequestI, which is a request API for the notification engine; (3) NotificationResponseI, which is a response API for the notification engine; (4) NotificationI, which is a notification instance interface for the notification engine; (5) NotificationMetadataI, which is an interface for accessing the metadata for notifications; and (6) NotificationSearchCriteriaI, which is an interface for searching for notifications. Regarding the last interface, a user could set the search criteria in a Notification request.

### Registering, Generating, and Sending Notifications

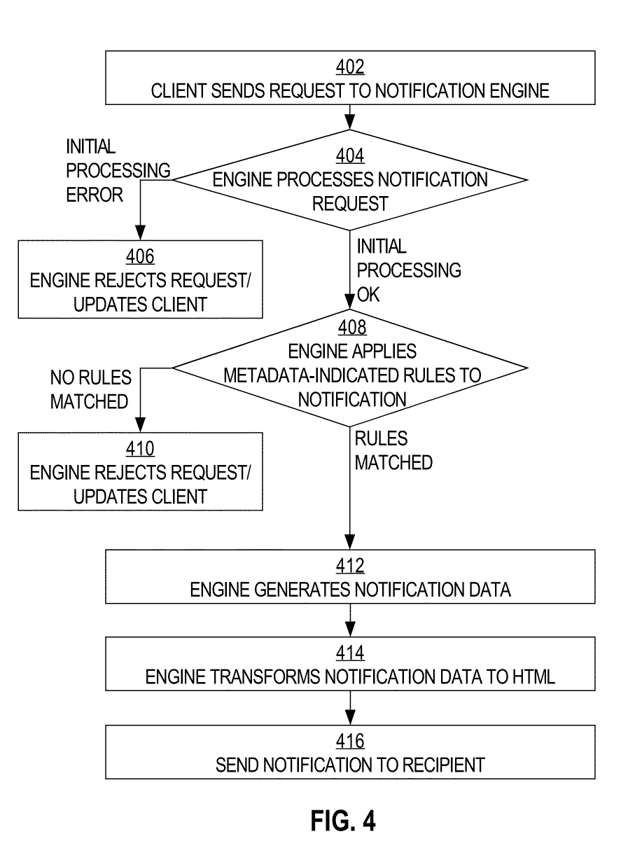

FIG. 4 is a flow diagram illustrating an example of an overview of a technique for processing client notification requests at a notification engine, generating notifications, and sending those notifications to recipients, according to an embodiment of the invention. In block 402, a client, such as an application, sends a request to the notification engine by calling the “NotificationServiceI.notify( )” method of the notification engine's API. As is discussed above, the request specifies a NotificationRequest object. Contents of a sample notification envelope are shown below:

```
<REQ>
! <NTFNLST>
! ! <NTFN>
! ! ! <CAUSALREQUESTID>2000235429
        </CAUSALREQUESTID>
! ! ! <TARGETSYSTEMID>21</TARGETSYSTEMID>
! ! ! <TARGETREALM>UAT</TARGETREALM>
! ! ! <SOURCESYSTEMID>500</SOURCESYSTEMID>
! ! ! <CONTEXT>APPROVER</CONTEXT>
! ! ! <ACTION>SUBMITTED</ACTION>
! ! ! <TRANSACTIONTYPE>SUBMITTED
        </TRANSACTIONTYPE>
! ! ! <RECIPIENTID>297989987</RECIPIENTID>
! ! ! <RECIPIENTTYPE>PERSON</RECIPIENTTYPE>
! ! ! <DATALST>
! ! ! ! <NTFNDATA>
! ! ! ! ! <CATEGORY>ContextData</CATEGORY>
! ! ! ! ! <NAME>REQSTR_ID</NAME>
! ! ! ! ! <TYPE>PERSON</TYPE>
! ! ! ! ! <VALUE>297988245</VALUE>
! ! ! ! </NTFNDATA>
! ! ! ! <NTFNDATA>
! ! ! ! ! <CATEGORY>ContextData</CATEGORY>
! ! ! ! ! <NAME>TRGT_ID</NAME>
! ! ! ! ! <TYPE>PERSON</TYPE>
! ! ! ! ! <VALUE>1439155774</VALUE>
! ! ! ! </NTFNDATA>
! ! ! </DATALST>
! ! </NTFN>
! </NTFNLST>
</REQ>
```

The notification engine receives the request, and, in block 404, the notification engine performs initial processing on the request. The initial processing, in one embodiment, involves determining whether the request object is well-formed and contains all required values. If the initial processing produces an error, then control passes to block 406. If the initial processing does not produce an error, then control passes to block 408.

In block 406, the notification engine rejects the request and updates the client by informing the client that the request has been rejected. In one embodiment, the notification engine performs this update through a notification to the client. Such a notification may indicate the reasons why the request was rejected. No further processing of the request is performed.

Alternatively, in block 408, the notification engine applies metadata-specified rules, or constraints, that are applicable to the NotificationRequest object that was specified in the request. If the object matches applicable rules that indicate that a notification is to be sent, then, once all the rules are validated and all the metadata (e.g., template, etc.) are extracted for the request, control passes to block 412. Alternatively, if the object does not match any applicable rules that indicate that a notification is to be sent, then control passes to block 410. Such rules could be simple constraints based on the target system or recipient. The rules could also be complex expressions that a caller can add to the system through service APIs.

In block 410, the notification engine rejects the request and updates the client by informing the client that the request has been rejected. In one embodiment, the notification engine performs this update through a notification to the client. Such a notification may indicate the reasons why the request was rejected. No further processing of the request is performed.

Alternatively, in block 412, the notification engine generates XML notification data for the notification and persistently stores the XML notification into the data store. The notification engine may generate the XML notification data, for example, by locating a template that matches the elements of the request-specified NotificationRequest object and applying the formatting specified by that template to the information contained with that object. In one embodiment of the invention, the application of the formatting may be performed at least in part by the application of one or more XML Stylesheets. Control passes to block 414.

The notification engine is task-based and asynchronous. After a certain interval, the notification engine awakens and looks for all processed notifications. The notification engine then divides the pending notifications into groups. In block 414, the notification engine transforms the notification data into Hypertext Markup Language (HTML), according to one embodiment of the invention. In alternative embodiments of the invention, instead of transforming the notification data into HTML, the notification engine transforms the data into some other presentation format. For example, that other presentation format might be a Short Message Service (SMS) message that can be transmitted to a mobile phone. For another example, that other presentation format might be an audio message (capable of being placed via a telephone call to a specified telephone number) or motion video message or audiovisual message that can be transmitted to a telephone or a mobile phone or a computer. The presentation format may be audible or visible or both, and may be textual or image-based or both.

In block 416, the notification engine calls a service provider to send, the transformed notification data to a recipient indicated by the data contained within the NotificationRequest object. If the notification data is HTML, then the service provider may send such the HTML message generated in block 414 to an e-mail address specified by the notification data. If the notification data is in some other format, then the service provider may sent the notification data via a channel that is appropriate for that other format. For example, if the notification data is an audio message, then the service provider may call a telephone number of the recipient and present the audio message over a telephonic channel.

In one embodiment of the invention, the notification engine is able to collate notifications to send to a specific user, so that the user receives a single communication representing multiple separate notifications. Example dispatching algorithms are discussed in greater detail further below.

### Generating a Notification Envelope

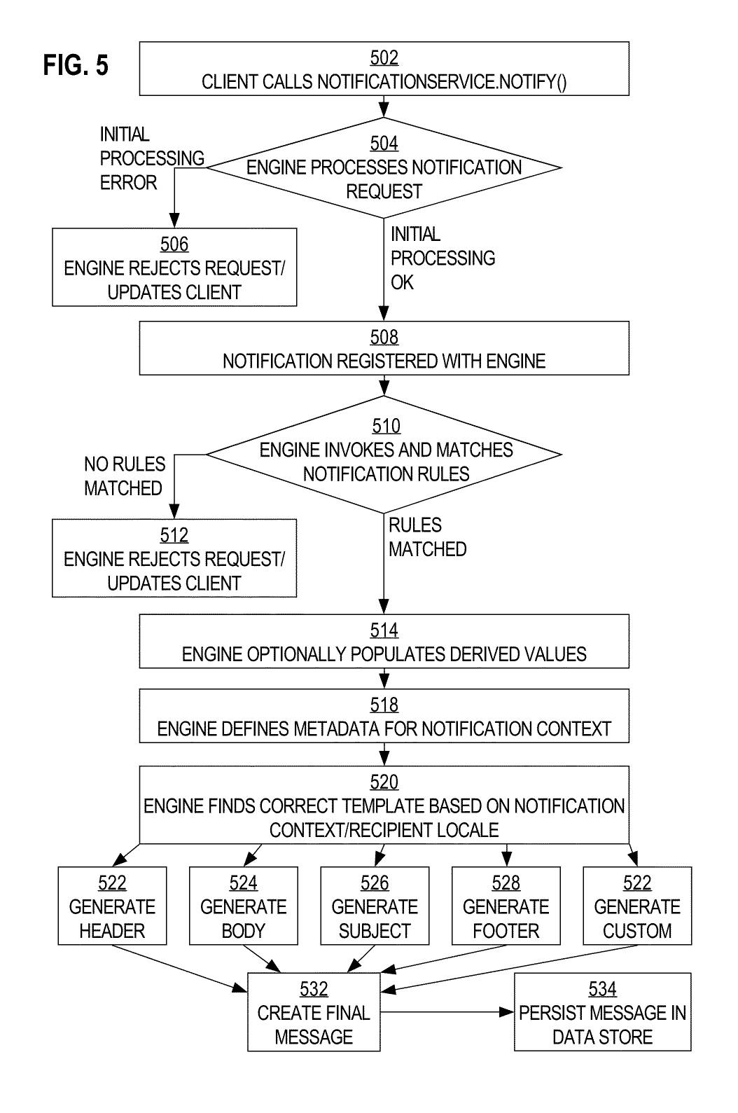

FIG. 5 is a flow diagram that illustrates a more detailed example of a technique that the notification engine can use to generate a notification envelope, according to an embodiment of the invention. In block 502, a client calls “NotificationService.notify( )” in order to request registration of a notification with the notification engine. In block 504, the notification engine processes the notification request. If the request contains errors, then control passes to block 506. If the request does not contain errors, then control passes to block 508.

In block 506, the notification engine rejects the request and updates the client, notifying the client that the request has been rejected. Alternatively, in block 508, the notification is registered with the notification engine.

Once the client has registered the notification with the notification engine, the notification engine synchronously processes the client's request and persistently stores the generated data in the database for dispatch later. In block 510, the notification engine invokes the matching rules for the notification. If no rules match the notification, then control passes to block 512. Alternatively, if at least some rules match the notification, then control passes to block 514.

In block 512, the notification engine rejects the request and updates the client, notifying the client that the request has been rejected. Alternatively, once the rules match, in block 514, the notification engine optionally populates all the derived values for the generated notification. For example, such derived values could include person information or account information which was not sent in detail during the registration process. Although clients external to a business organization are expected to send all of the details for a notification up-front in the registration request, clients internal to the business organization may be exempted from sending the notification engine all of this data during notification registration. In one embodiment of the invention, the notification engine is sufficiently flexible to ensure that if the client does not want to send all of the detailed notification information during the registration process, the client can instead register, with the notification engine, a URL through which the notification engine can later (i.e., in block 514 rather than earlier) derive all the values required to populate the generated notification.

In block 518, metadata for the notification context is defined. According to one embodiment of the invention, as is discussed above with reference to FIG. 2, this context is a combination of the recipient, notification type, action, and transaction ID, as indicated in the notification header table.

In block 520, once the context of the notification is finalized, the engine derives, or selects, the correct template for the specific notification context. According to one embodiment of the invention, the client is responsible for ensuring that a template for the notification context is registered with the notification engine; in such an embodiment of the invention, the absence of such a template causes the notification registration mechanism to fail. In one embodiment of the invention, the template is selected based not only upon the notification context, but also based on a locale of an intended notification recipient.

Once the correct template has been derived, or selected, the notification engine starts to collate all of the different parts of the template, such as the header, footer, body, etc. As is discussed above, the template might be a standardized pre-defined template, or parts of such a template might have been specifically overridden during template registration with customized portions for the specific notification context. If the any part of the notification is to be customized (i.e., as a deviation in part from a standardized template), then the notification engine populates the generated notification by adding the custom templates instead of merely swapping values in a single standard template. As is shown in FIG. 5, a header may be generated in block 522, a body may be generated in block 524, a subject may be generated in block 526, a footer may be generated in block 528, and other miscellaneous custom parts may be generated in block 530.

In block 532, the notification generates the final notification message, potentially by assembling all of the constituent parts generated in blocks 522-530. The final notification message essentially is the template into which derived values (e.g., account information, privilege information, etc.) have been entered. In block 534, the notification engine persistently stores this final notification message in the database in any format (e.g., text or XML). In one embodiment of the invention, the final notification message is stored using XML format so that the message can later be transformed into HTML with XML Stylesheets easily. However, if the client decides to choose a different output format, then the notification engine can replace the transformation mechanism that will be used to transform the notification for a specific system or recipient. In one embodiment of the invention, the notification engine stores the generated notification data in relational database, but in alternative embodiments of the invention, the notification engine may persistently store the generated notification data in any other kind of data store (e.g., a Lightweight Directory Access Protocol (LDAP) directory or a flat file-based data store).

### Dispatching Notifications to Recipients

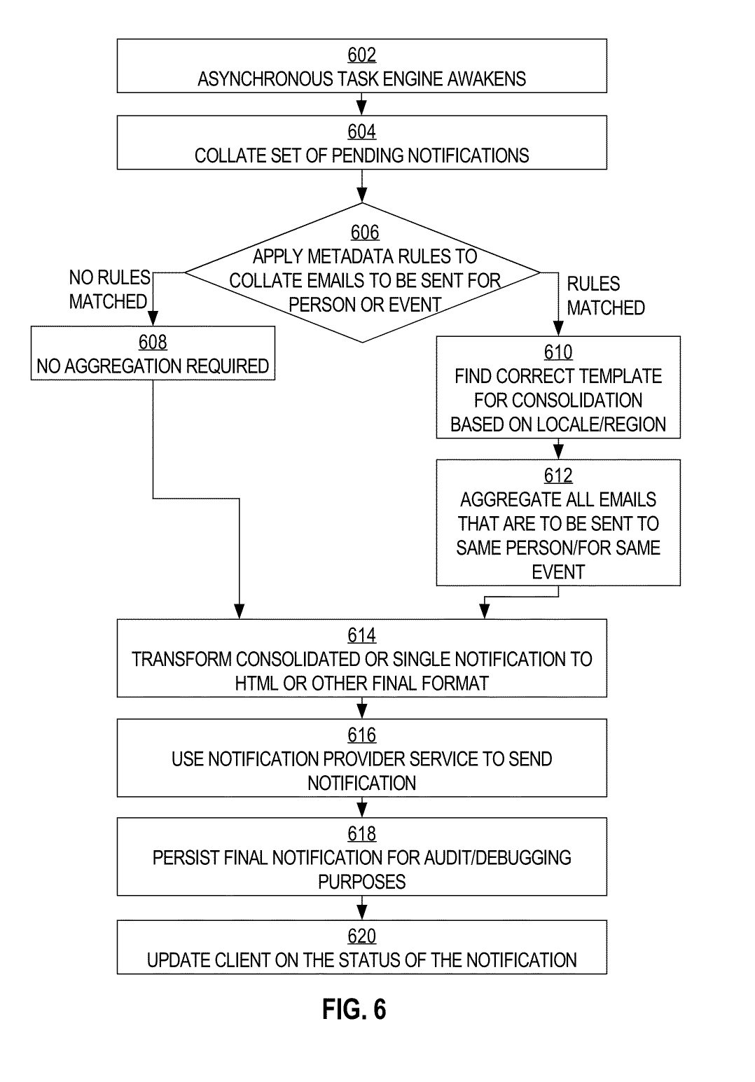

FIG. 6 is a flow diagram that illustrates a more detailed example of a technique that the notification engine can use to dispatch a notification to a recipient, according to an embodiment of the invention. The notification engine is task-based and asynchronous. In block 602, the notification engine awakens after a predefined period of time and finds all notifications that are pending. Instead of sending all the notifications separately, the notification engine can pre-process all notifications that belong to a specific user or system and send a single collated email containing all of the information from all of those notifications. In block 604, the notification engine collates the set of pending notifications.

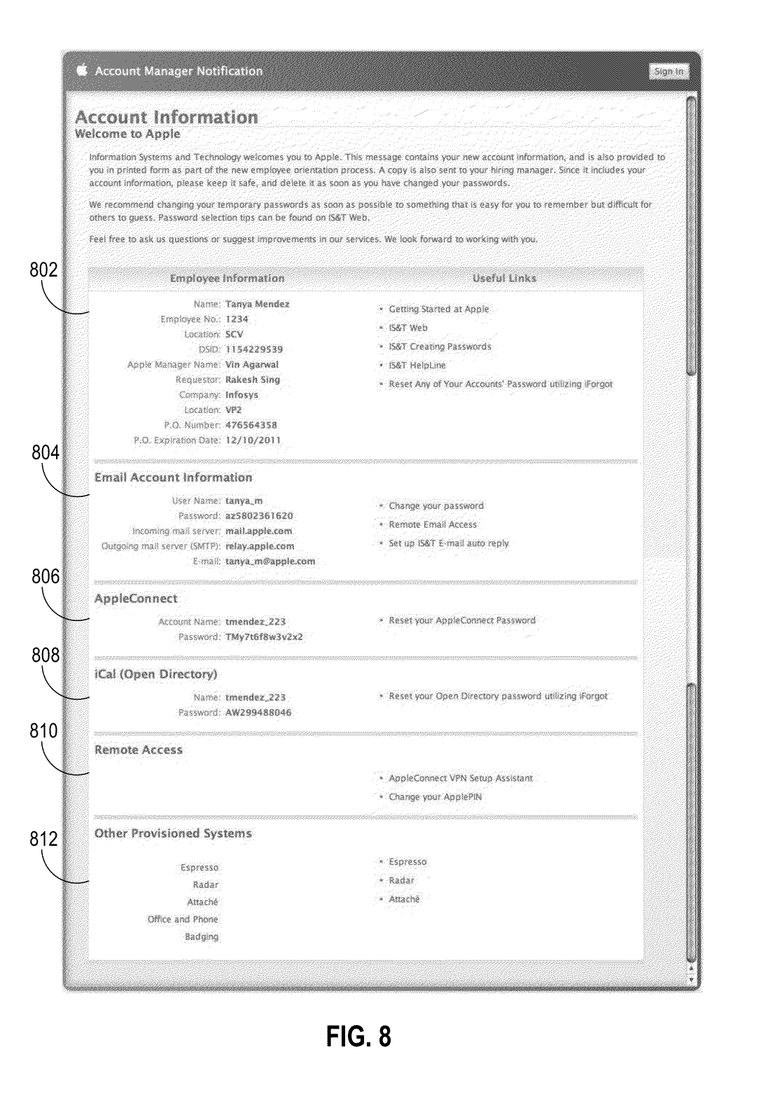

For example, when a new employee or contractor joins a company, the notification engine can generate the first welcome e-mail as a consolidated list of all accounts that were provisioned for the recipient employee or contractor. The new employee's manager might prefer a single email for all the accounts rather than dozens of emails spread over a period of time, so the notification engine can generate a single consolidate e-mail for the manager as well. A similar usefulness for collation can be imagined when the employee or contractor is not longer employed and his/her accounts need to be de-activated. Collation can be time-based or based on a constraint which indicates that collation is to be performed once certain systems are provisioned. FIG. 8 is a diagram that illustrates a screenshot of a collated message of the kind that is produced by one embodiment of the invention. The collated message includes information from notifications 802-812. Each of notifications 802-812 originated from a different application, potentially at different times. The collated message compiles all of the information from notifications 802-812 into a single message that has a separate section for each notification. Additionally, each of notifications 802-812 aggregated into the collated message includes one or more helpful links (to various different specified URLs), which, in one embodiment, are extracted from useful links table 112 discussed above in relation to FIG. 1. Application of a template to the aggregated notifications causes the single message to have a unified look and feel that notifications 802-812 might not otherwise share had they been dispatched separately.

In block 606, the notification engine applies rules from the notification metadata to collate e-mails that should be sent to a specified person or for (i.e., in response to) a specified event. For each pending notification, the notification engine determines whether the rules that indicate that collation should be performed match that pending notification. If a particular pending notification does not match any of these rules, then, relative to that notification, control passes to block 608. Alternatively, if the particular pending notification matches one or more of these rules, then control passes to block 610.

In block 608, no aggregation is required; the pending notification can be placed in a single e-mail message of its own. Control passes to block 614.

Alternatively, in block 610, the notification engine finds, or selects, the correct template for the pending notification based on a locale or region of either the recipient or some other user, such as the user that originally registered the notification. Control passes to block 612, in which the notification engine aggregates all e-mails that are to be sent to the same person or for (i.e., in response to) the same event. Aggregation causes information from the multiple e-mails to be placed in a group. Control then passes to block 614.

According to one embodiment of the invention, depending on whether the final output will be collated (when aggregation was performed) or sent as a single notification (when aggregation was not performed), the specific transformation stylesheet selected to transform the e-mail will differ. Application of the stylesheet causes the notification data to be transformed into to the final format, which may be HTML, for example. Thus, a stylesheet selected to transform a group of aggregated notifications may assemble the information from all of the notifications in the aggregated group into a single collated e-mail message. In block 614, the notification engine transforms the consolidated or single notification into HTML (e.g., by applying the appropriately selected stylesheet to either the group of aggregated notifications or the single notification) or some other specified format (e.g., an audio presentation).

In block 616, once the transformation of block 614 is completed, a pluggable service provider is called, and the email (according to one embodiment of the invention) is sent. In block 618, the final email (according to one embodiment of the invention) is also persisted in the database for future reference or audit purposes. In block 620, after the notification has been dispatched, the client that registered the notification is also notified of the final state of the notification. The client may be notified via a URL that the client previously registered in association with the notification when the client invoked the “notify( )” method of the notification engine's API.

### Report Generation

In one embodiment of the invention, the notification engine also has to the capacity to harvest (e.g., from the database to which the final notification data has been persisted) all notifications sent during a specified time interval. The notification engine can generate daily reports based on this harvested information. The notification engine can automatically send such daily reports to managers or application owners who are interested in such reports.

In one embodiment of the invention, in response to one instance of the notification engine detecting that it is under a very high load (i.e., over a specified threshold load amount), that instance sends monitoring reports to a system administrator, asking the administrator to shut down that instance and fail over to another instance of the notification engine, which can start processing notifications from the point where the previous instance of the notification engine left off.

### Administrative User Interface

Certain notifications could become blocked, or halted due to errors, as a result of those notifications not being processed correctly. Such notifications are considered to be “stuck.” In one embodiment of the invention, in order to remedy this situation, the notification engine provides an administrative user interface through which an administrator can manipulate any “stuck” notification. The administrator may do so via use of the notification engine's APIs—and, more specifically, by calling methods like find/fetch notification, as discussed above and then manually sending the notifications that are found to have been stuck. This feature of the notification engine helps to ensure that if a critical notification was missed for any reason, the administrator can debug the information by pulling out the notification data in the administrative user interface. The administrative user interface can also be used for compliance purposes, to fetch notifications previously sent during any prior time period for auditing or any other purpose.

### Asynchronous Task Processor

According to one embodiment of the invention, a task engine of the notification engine provides a unified interface to execute tasks (activities) asynchronously in a clustered environment. The task engine does this by recognizing whether a task needs to be executed locally or remotely. The tasks are defined and configured. The task definition contains the task name, description, priority, etc., and can contain a regular expression of the instance parameters that the task expects to run. The configuration is the instance of the definition with concrete instance parameters and other configurations such as designated server, etc. The definition can be compared to a class definition or a method signature, while the configuration is similar to the actual instance of the class or method invocation.

Since the task engine is aware that it is running in a clustered environment, the task engine can distribute load among available servers. The task engine is able to do this based on the task performance metrics collected from each task run. The task engine can detect long-running tasks and hung tasks based on accumulated metrics over a period of time. In case such situations are detected, the task engine can run the task on the best available server in the cluster. Due to this feature, if the task is performing a heavy operation with regard to time taken and if the task can be split into chunks (sub tasks), then the task engine can distribute such chunks throughout the cluster for quicker completion. This feature also enables failover, which may be either designated or decided at runtime. The task engine makes sure that this failover happens cleanly by initiating a proper handshake.

According to one embodiment of the invention, each task has a predefined priority or is submitted with some priority. The task engine ensures that the tasks are scheduled according to their priority. Starvation can be avoided by performing load distribution, as mentioned above.

The task engine provides a clean mechanism to submit a task for execution. The task, once submitted (to the task manager), can be executed anywhere, using designated machines in the cluster, or based on convenience with a goal of reducing load on each machine. In one embodiment of the invention, the user/caller is unaware of where a particular task is being executed. Since the task is of asynchronous nature, the task engine also provides an API to poll for the task status. The API provides comprehensive metrics of the task's execution.

### Constraints

In one embodiment of the invention, constraints are defined inside the metadata, which, in turn, points to the template to be used to generate and send a notification. The constraints add to the notification engine's ability to classify notifications based on derived and supplied values. Constraints are simple, lightweight, one-level rules that can be evaluated easily. Apart from the main criteria of context, action, and transaction type, which are the primary classifiers, there can be several other rules associated with the notification.

For example, a rule might indicate that Japanese language e-mails are to be sent to people in Japan. Rules may indicate various foreign language templates that are to be used to compose messages in those foreign languages for various corresponding locales. For another example, a rule might indicate that a copy of a particular e-mail is to be sent to the manager of the recipient. For another example, a rule might indicate that if a recipient belongs to a specified department, then a copy of the notification is to be sent to a department e-mail alias. For another example, a rule might indicate that a particular notification is only to be dispatched after another specified notification has been dispatched.

The above rules are just example rules, but they are often used to dispatch notifications across a business organization. As can be seen from the above discussion, there is virtually no limit to the variety of rules that can be defined. No static data structure is sufficient to capture all such possible rules. However, constraints, used in an embodiment of the invention, provide a mechanism to define such rules. An example constraint may look like the following:

CONS:srcSysId:=:55;trgtSysld:!=:263,604;trgtRlm:=:UAT;trgtRgn:!=:CORP
::ACT:cc:=:valueOf(trgtUsrMgr)

### ::DEP:any:=:1234,2345;all:=:898,768

The above constraint has 3 parts associated to it:

1. CONS:srcSysId:=:55;trgtSysld:!=:263,604;trgtRlm:=:UAT;trgtRgn:!=:CORP

This is a constraint which acts as a classifier for this metadata. Only notifications having source system 55 and a target system not in 263 or 604 and realm UAT and region not CORP will qualify for this metadata. The values of these elements can be derived by the notification engine if they are not supplied by the caller during registration. In case the caller wants to supply the values, the caller is free to do so in name-value pairs in the request for registering the notification.

2. ACT:cc:=:valueOf(trgtUsrMgr)

This part specifies that the mail should be copied to the manager of the recipient.

3. DEP:any:=:1234,2345;all:=:898,768

This part specifies that notifications having such metadata must wait for other notifications to be dispatched before notifications having such metadata can be sent to their recipients.

### Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

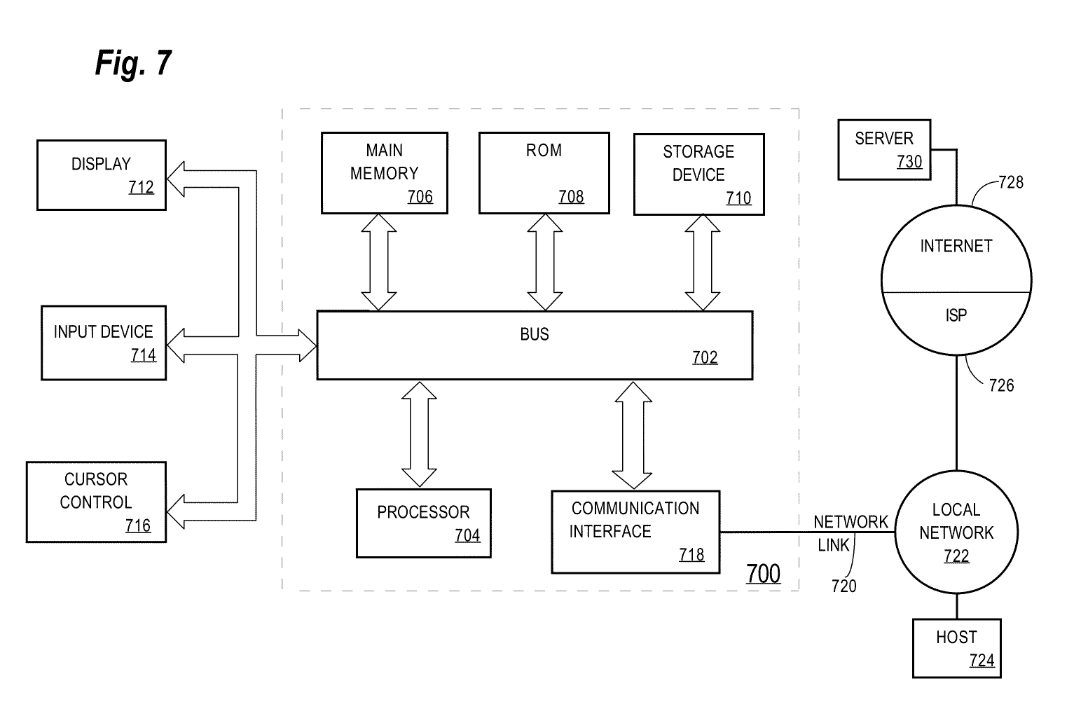

For example, FIG. 7 is a block diagram that illustrates a computer system 700 upon which an embodiment of the invention may be implemented. Computer system 700 includes a bus 702 or other communication mechanism for communicating information, and a hardware processor 704 coupled with bus 702 for processing information. Hardware processor 704 may be, for example, a general purpose microprocessor.

Computer system 700 also includes a main memory 706, such as a random access memory (RAM) or other dynamic storage device, coupled to bus 702 for storing information and instructions to be executed by processor 704. Main memory 706 also may be used for storing temporary variables or other intermediate information during execution of instructions to be executed by processor 704. Such instructions, when stored in non-transitory storage media accessible to processor 704, render computer system 700 into a special-purpose machine that is customized to perform the operations specified in the instructions.

Computer system 700 further includes a read only memory (ROM) 708 or other static storage device coupled to bus 702 for storing static information and instructions for processor 704. A storage device 710, such as a magnetic disk or optical disk, is provided and coupled to bus 702 for storing information and instructions.

Computer system 700 may be coupled via bus 702 to a display 712, such as a cathode ray tube (CRT), for displaying information to a computer user. An input device 714, including alphanumeric and other keys, is coupled to bus 702 for communicating information and command selections to processor 704. Another type of user input device is cursor control 716, such as a mouse, a trackball, or cursor direction keys for communicating direction information and command selections to processor 704 and for controlling cursor movement on display 712. This input device typically has two degrees of freedom in two axes, a first axis (e.g., x) and a second axis (e.g., y), that allows the device to specify positions in a plane.

Computer system 700 may implement the techniques described herein using customized hard-wired logic, one or more ASICs or FPGAs, firmware and/or program logic which in combination with the computer system causes or programs computer system 700 to be a special-purpose machine. According to one embodiment, the techniques herein are performed by computer system 700 in response to processor 704 executing one or more sequences of one or more instructions contained in main memory 706. Such instructions may be read into main memory 706 from another storage medium, such as storage device 710. Execution of the sequences of instructions contained in main memory 706 causes processor 704 to perform the process steps described herein. In alternative embodiments, hard-wired circuitry may be used in place of or in combination with software instructions.

The term “storage media” as used herein refers to any non-transitory media that store data and/or instructions that cause a machine to operation in a specific fashion. Such storage media may comprise non-volatile media and/or volatile media. Non-volatile media includes, for example, optical or magnetic disks, such as storage device 710. Volatile media includes dynamic memory, such as main memory 706. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 702. Transmission media can also take the form of acoustic or light waves, such as those generated during radio-wave and infra-red data communications.

Various forms of media may be involved in carrying one or more sequences of one or more instructions to processor 704 for execution. For example, the instructions may initially be carried on a magnetic disk or solid state drive of a remote computer. The remote computer can load the instructions into its dynamic memory and send the instructions over a telephone line using a modem. A modem local to computer system 700 can receive the data on the telephone line and use an infra-red transmitter to convert the data to an infra-red signal. An infra-red detector can receive the data carried in the infra-red signal and appropriate circuitry can place the data on bus 702. Bus 702 carries the data to main memory 706, from which processor 704 retrieves and executes the instructions. The instructions received by main memory 706 may optionally be stored on storage device 710 either before or after execution by processor 704.

Computer system 700 also includes a communication interface 718 coupled to bus 702. Communication interface 718 provides a two-way data communication coupling to a network link 720 that is connected to a local network 722. For example, communication interface 718 may be an integrated services digital network (ISDN) card, cable modem, satellite modem, or a modem to provide a data communication connection to a corresponding type of telephone line. As another example, communication interface 718 may be a local area network (LAN) card to provide a data communication connection to a compatible LAN. Wireless links may also be implemented. In any such implementation, communication interface 718 sends and receives electrical, electromagnetic or optical signals that carry digital data streams representing various types of information.

Network link 720 typically provides data communication through one or more networks to other data devices. For example, network link 720 may provide a connection through local network 722 to a host computer 724 or to data equipment operated by an Internet Service Provider (ISP) 726. ISP 726 in turn provides data communication services through the world wide packet data communication network now commonly referred to as the “Internet” 728. Local network 722 and Internet 728 both use electrical, electromagnetic or optical signals that carry digital data streams. The signals through the various networks and the signals on network link 720 and through communication interface 718, which carry the digital data to and from computer system 700, are example forms of transmission media.

Computer system 700 can send messages and receive data, including program code, through the network(s), network link 720 and communication interface 718. In the Internet example, a server 730 might transmit a requested code for an application program through Internet 728, ISP 726, local network 722 and communication interface 718.

The received code may be executed by processor 704 as it is received, and/or stored in storage device 710, or other non-volatile storage for later execution.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction

What is claimed is:

1. A computer-implemented method comprising:
receiving, from a particular application, a request to register a notification with a centralized notification engine that serves notifications from multiple different applications;
in response to receiving the request, the notification engine storing information that indicates a context of the notification;
determining, at the notification engine, whether one or more constraints are satisfied;
in response to determining that the one or more constraints are satisfied, the notification engine selecting, from a set of templates, a particular template that is associated with the context of the notification;
in response to the selection of the particular template, applying the particular template to information specified by the notification, thereby producing a populated template; and
sending, to a recipient specified within the information, a message that was produced based on the populated template;
wherein the one or more constraints express rules for the notification engine;
wherein the method is performed by one or more computing devices.

2. The method of claim 1, further comprising:
calling a transformation mechanism from the notification engine to transform the populated template into a document having a format different from a markup language used to format the populated template;
wherein sending the message comprises sending, to the recipient, an e-mail message that contains the document.

3. The method of claim 1, further comprising:
calling a transformation mechanism from the notification engine to transform the populated template into an audio presentation;
wherein sending the message comprises automatically calling a telephone number of the recipient and presenting the audio presentation over a telephonic channel.

4. The method of claim 1, further comprising:
determining whether the notification satisfies rules that indicate that the notification should be collated with one or more other notifications prior to being any of the one or more other notifications being sent to the recipient; and
in response to determining that the notification should be collated with the one or more other notifications, aggregating information from the notification and the one or more other notifications into an information group; and
applying a stylesheet to the information group to produce a single collated message.

5. The method of claim 1, further comprising:
determining, based on stored metadata, that a part of the particular template is to be overridden; and
in response to determining that the part of the particular template is to be overridden, applying a second template to a portion of the information in order to produce a custom notification portion that does not conform to the particular template;
wherein the custom notification portion is a header, footer, subject, or body of the message.

6. The method of claim 1, further comprising:
after the sending of the message, the notification engine sending, on a reminder date specified within data of the notification, a reminder pertaining to the message.

7. A computer-implemented method comprising:
receiving, from a particular application, a request to register a notification with a notification engine;
wherein the notification comprises particular information that indicates a locale of an intended recipient of the notification;
determining, at the notification engine, that the notification satisfies a constraint that indicates that the notification is to be formatted in a particular manner that is based on the locale;
in response to determining that the notification satisfies the constraint, the notification engine selecting, from a set of templates, a particular template that is associated with the locale;
in response to the selection of the particular template, applying the particular template to information specified by the notification, thereby producing a populated template that is designed specifically for the locale; and
sending, to a recipient specified within the information, a message that was produced based on the populated template;
wherein the method is performed by one or more computing devices.

8. The method of claim 7, wherein the step of applying the particular template to the information comprises applying, to the information, a foreign language template that is composed in a foreign language that is used to converse in the locale.

9. A computer-implemented method comprising:
receiving, from a particular application, a request to register a notification with a notification engine;
registering the notification at the notification engine in response to the request;
selecting, from among a plurality of templates, each of which specifies a different appearance that is independent of notification content, a particular template that specifies a particular appearance;
applying the particular template to content of the notification, thereby producing an Extensible Markup Language (XML) document that is structured in a manner that will cause the particular appearance;
selecting, from among a plurality of different XML Stylesheets, a particular XML Stylesheet engine that transforms the XML document into a particular format;
applying the particular XML Stylesheet to the XML document to produce a message in the particular format;
causing the message to be sent to a recipient; and
persistently storing the message in a repository of messages along with data indicating details regarding transmission of the message to the recipient;
wherein the method is performed by one or more computing devices.

10. The method of claim 9, further comprising:
receiving, at the notification engine, via an invocation of a particular method of an application programming interface of the notification engine, either a specified notification identifier or a pattern indicated by a specified string;
executing the query at the notification engine to select, from the repository, one or more stored messages including the particular message in the particular format; and
returning, from the notification engine, in response to the invocation of the particular method, both the particular message in the particular format and the details regarding transmission of the message to the recipient.

11. One or more storage media storing instructions which, when executed by one or more processors, causes performance of the method recited in claim 1.

12. One or more storage media storing instructions which, when executed by one or more processors, causes performance of the method recited in claim 2.

13. One or more storage media storing instructions which, when executed by one or more processors, causes performance of the method recited in claim 3.

14. One or more storage media storing instructions which, when executed by one or more processors, causes performance of the method recited in claim 4.

15. One or more storage media storing instructions which, when executed by one or more processors, causes performance of the method recited in claim 5.

16. One or more storage media storing instructions which, when executed by one or more processors, causes performance of the method recited in claim 6.

17. One or more storage media storing instructions which, when executed by one or more processors, causes performance of the method recited in claim 7.

18. One or more storage media storing instructions which, when executed by one or more processors, causes performance of the method recited in claim 8.

19. One or more storage media storing instructions which, when executed by one or more processors, causes performance of the method recited in claim 9.

20. One or more storage media storing instructions which, when executed by one or more processors, causes performance of the method recited in claim 10.
